(19) United States
(12) Patent Application Publication
(10) Pub. No.: US 2003/0076453 A1
(43) Pub. Date: Apr. 24, 2003

(54) Flat display with securing device

(76) Inventor: Hsi Kuang Ma, Taipei (TW)

Correspondence Address: JOHNSON & ASSOCIATES, P.C., 14625 Baltimore Avenue #282, Laurel, MD, 20707, US

(21) Appl. No.: 10/025,625

(22) Filed: Dec. 26, 2001

(30) Foreign Application Priority Data
Oct. 24, 2001 (TW) 090218186

(51) Int. Cl. G02F 1/136; G02F 1/1333

(52) U.S. Cl. 349/50

(57) ABSTRACT

A flat display with a securing device includes a securing device disposed on the flat display at a position other than a display panel of the flat display. The securing device may be a band or a ring.

### BACKGROUND OF THE INVENTION

1. Field of The Invention

The present invention relates to a flat display provided with a securing device to facilitate fastening of the flat display to a fixed object.

2. Description of Related Art

Flat displays are used for output of images. Since a flat display is separated from its main module, it affords flexibility and mobility in terms of installation. Therefore, flat displays are quite common today.

A conventional flat display in general includes a flat seat member accommodating circuit boards and electronic components therein, a display, which is usually a liquid crystal display, disposed at a front end. In addition, a connector is provided for external connection to a control module, such as a playback module like VCD, DVD.

As mentioned above, flat displays provide high mobility, and can be installed in many environments. However, in actual use, the conventional flat display has to be secured via various securing means and, in some cases, may need to damage the original facilities, for instance, when mounted at the front of a car compartment.

### SUMMARY OF THE INVENTION

Therefore, the primary object of the present invention is to provide a flat display with a securing device so as to overcome the drawbacks associated with the prior art.

### BRIEF DESCRIPTION OF THE DRAWINGS

The foregoing and other features and advantages of the present invention will be more clearly understood from the following detailed description and the accompanying drawings, in which,

FIG. 1 is a schematic perspective view of the first preferred embodiment of the present invention;

FIG. 2 is a schematic perspective view of the second preferred embodiment of the present invention; and

FIG. 3 is a perspective view of the present invention in a state of use.

### DETAILED DESCRIPTION OF THE PREFERRED EMBODIMENTS

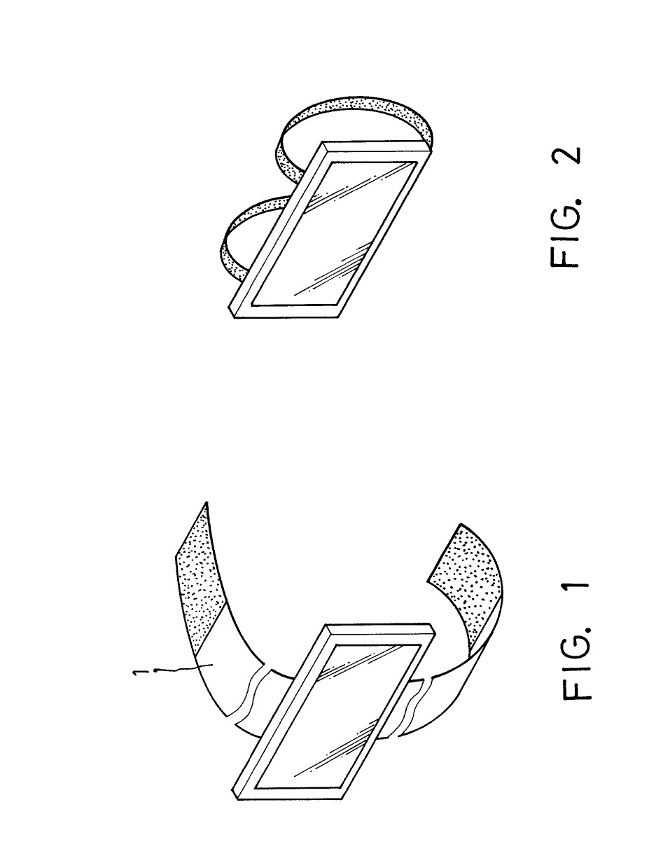

As shown in the drawings, a flat display according to the present invention is a flat display provided with a securing device 1. As shown in FIG. 1, the securing device 1 includes hooks-and-loops fasteners respectively disposed at upper and lower ends of the flat display and inter-connectable to form a loop. The flat display can therefore be secured to a fixed object, for instance, a head rest of a car seat, by inter-connecting the hooks-and-loops fasteners.

Referring to FIG. 2, the securing device includes elastic bands that are in the form of rings. The elastic bands are fitted around a fixed object so as to secure the flat display thereon.

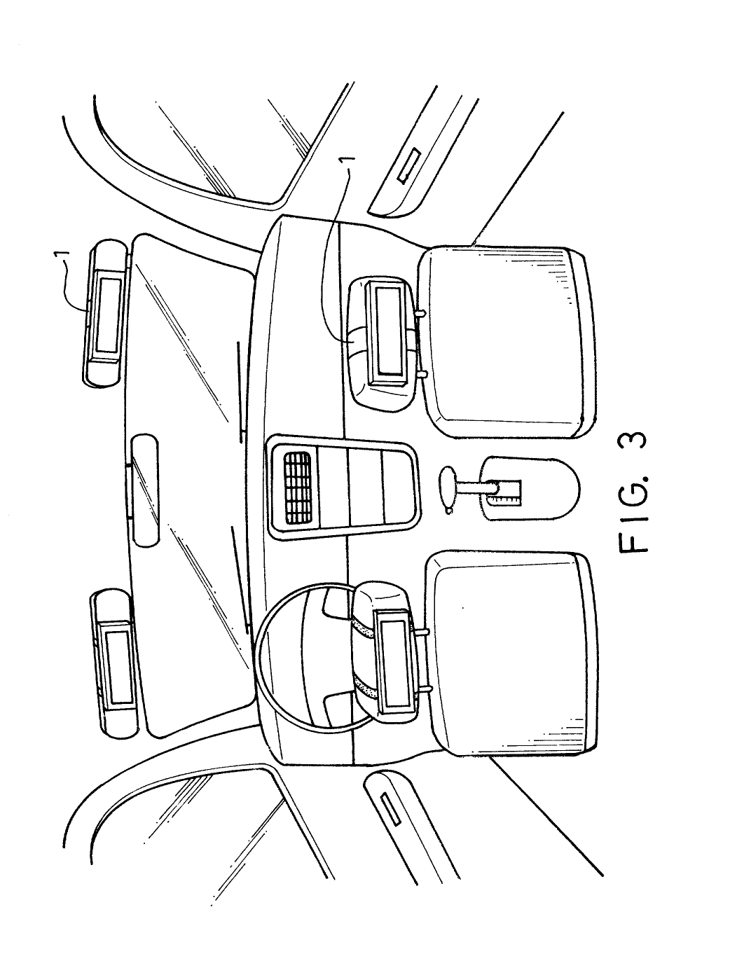

In actual use, referring to FIG. 3, a flat display is fastened to the headrest of the driver's seat by means of the elastic bands, while another flat display is fastened to the headrest of the seat next to the driver's seat by tying the hooks-and-loops fasteners therearound and interconnecting the hooks-and-loops fasteners.

Although the present invention has been illustrated and described with reference to the preferred embodiments thereof, it should be understood that it is in no way limited to the details of such embodiments but is capable of numerous modifications within the scope of the appended claims.

What is claimed is:

1. A flat display with a securing device, comprising a flat display having a display panel portion and a securing device disposed on said flat display at a position other than said display panel portion, said securing device being in the form of a band or ring.

2. The flat display with a securing device as claimed in claim 1, wherein said securing device includes two hooks-and-loops fasteners that are inter-connectable to form a loop.

3. The flat display with a securing device as claimed in claim 1, wherein said securing device includes an annular elastic band member.

4. The flat display with a securing device as claimed in claim 1, wherein said elastic band member includes two or more annular elastic bands.
